(19) United States
(12) Patent Application Publication
(10) Pub. No.: US 2015/0321763 A1
(43) Pub. Date: Nov. 12, 2015

(54) CRASHWORTHY BENCH

(71) Applicants: Philippe BREL, Bourges (FR); Julien DHERMAND, Neuvy Pailloux (FR); ZODIAC SEATS FRANCE, Issoudun (FR)

(72) Inventors: Philippe Brel, Bourges (FR); Julien Dhermand, Neuvy Pailloux (FR)

(73) Assignee: Zodiac Seats France, Issoudun (FR)

(21) Appl. No.: 14/646,133

(22) PCT Filed: Nov. 20, 2013
(86) PCT No.: PCT/IB2013/060279

§ 371 Date: May 20, 2015

Related U.S. Application Data
(60) Provisional application No. 61/728,917, filed on Nov. 21, 2012.

(51) Int. Cl. B64D 11/06

(52) U.S. Cl. CPC B64D 11/0619; B64D 11/0697; B64D 11/0696

(57) ABSTRACT

Embodiments of the present invention provide benches for use in aircraft, and particularly in rotor aircraft, that can absorb certain crash forces.

### CROSS REFERENCE TO RELATED APPLICATIONS

This application claims the benefit of U.S. Provisional Application Ser. No. 61/728,917, filed Nov. 21, 2012, titled “Crashworthy Passenger Bench,” the entire contents of each of which are hereby incorporated by reference.

### FIELD OF THE INVENTION

Embodiments of the present invention relate generally to benches for use in aircraft, and particularly in rotor aircraft, that can absorb certain crash forces.

### BACKGROUND

Aircraft regulations require that seats be capable of absorbing various levels of crash impacts. Crashworthiness is the ability of an aircraft to maintain a protective space for occupants throughout a crash impact sequence. One primary goal is to limit the magnitude and duration of accelerations and loads experienced by the aircraft occupants to within survivable levels. Rotorcraft regulations for military aircraft and civil helicopters are of particular interest to the present disclosure.

Crashworthy seats and restraint systems provided on a rotorcraft are intended to securely restrain the occupants and minimize secondary impacts with the rotorcraft interior during a crash impact. Crashworthy seats are also intended to reduce the loads experienced by the occupants. During a crash, the seat may be designed to move vertically downward, referred to as seat stroke. Seat stroke mitigates spinal injury by spreading the crash impulse over time and decreasing the magnitude of the force transmitted to the seat occupant. The seat stroke is typically accomplished by discrete energy absorbing (EA) devices that allow relative motion between the seat bucket and the seat frame attached to the airframe structure.

For example, rotorcraft regulations for military aircraft and helicopters require that the seat systems be provided with an energy absorber to attenuate the acceleration level sustained by the seat occupants. This can help protect the seat occupants in case of an emergency landing or vertical crash. Current seat energy absorber technologies includes fixed load energy absorbers (FLEA) that are designed for a specific occupant weight, as well as variable load energy absorbers (VLEA) that can be adjusted for varying occupant weights. The load in the lumbar area should generally be less than or limited to 1500 pounds in case of a vertical deceleration of 30 g down.

### BRIEF SUMMARY

Embodiments described herein provide a crashworthy bench for an aircraft that can absorb the required loads, but that can also reduce the weight of the aircraft by supporting more than one passenger per bench. Embodiments also provide a system for securing an energy absorber to a crashworthy seat back (whether on a bench seat or an individual seat) using a ball joint/groove configuration. The configuration can help reduce deformation that might otherwise be experienced by the bench or individual seat.

### BRIEF DESCRIPTION OF THE DRAWINGS

FIG. 1 shows a rear perspective view of a crashworthy bench according to one embodiment.

FIG. 2 shows a front perspective view of a crashworthy bench that has lower attachment legs for securement to a seat track.

FIG. 3 shows a front perspective view of a crashworthy bench that has side lower attachment points for securement to a bulkhead.

FIG. 4 shows a rear perspective view of a system for securing an energy absorber to a crashworthy bench seat back.

FIG. 5 shows an exploded view of a crashworthy bench seat back.

### DETAILED DESCRIPTION

Embodiments of the present invention provide a crashworthy bench. Although there have been attempts to manufacture a single crashworthy seat, there is not currently provided an appropriate crashworthy bench that can accommodate two or more seats in a single bench. Whereas larger commercial passenger aircraft typically include bench seating, bench seats have not been explored or developed for rotorcraft use, likely due to the crashworthy regulations that must be met. However, the single crashworthy rotorcraft seats must each have two legs or other aircraft attachment points per seat, which adds to the weight of the overall craft. For example, for three seats, there must be three separate attachment systems, which generally equates to six separate attachment legs.

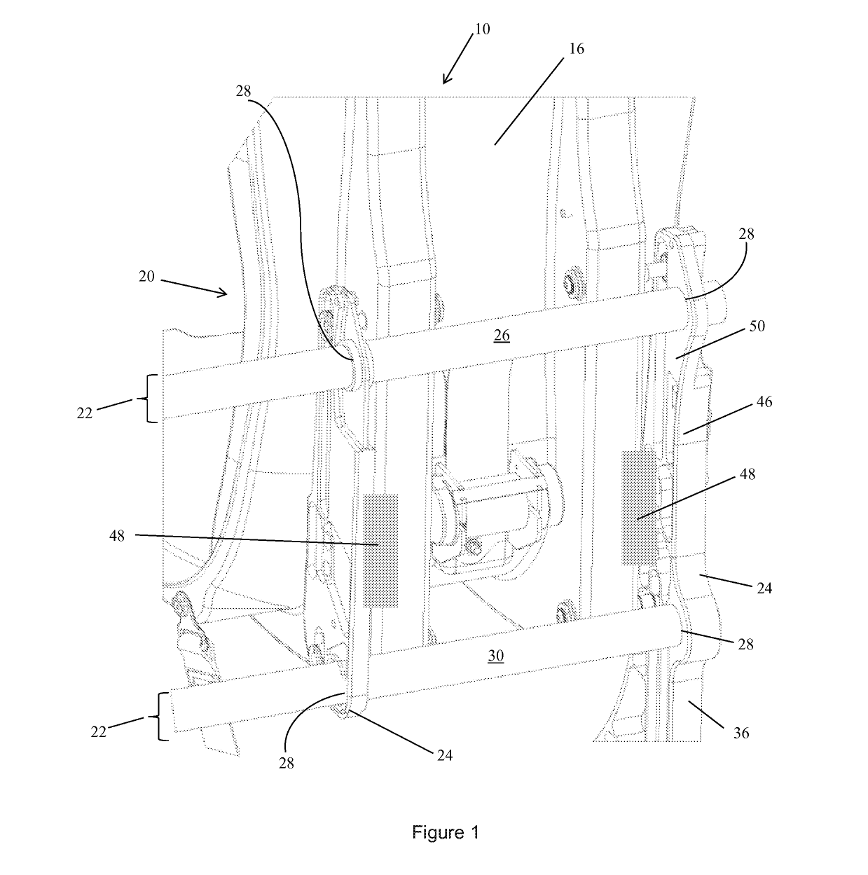

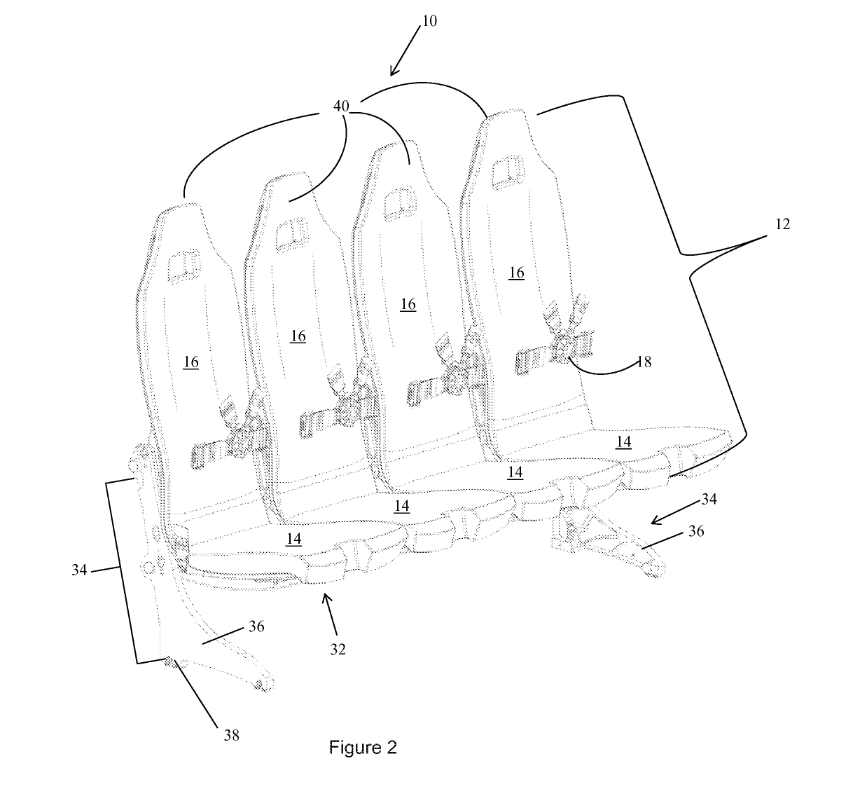

FIG. 1 shows a rear view of one embodiment a crashworthy bench 10. FIG. 2 shows a front view of one embodiment of a crashworthy bench 10 with a bench securing structure 34 positioned alongside each side of the bench 10. The bench securing structure 34 may be a leg structure 36 positioned alongside first and second sides of the bench 10, with each securing structure 34 configured for securement to an aircraft floor, seat track, or bulkhead. The bench 10 generally has an upper seat structure 12 which includes two or more seat bottom pans 14 and two or more seat backs 16. As typical, the upper seat structure 12 also has a passenger restraint system 18, which is generally a multi-point seat belt system for each seat in the bench 10. The seat bottom pans 14 and the seat backs 16 may be provided as separate structures that are hingedly connected. Alternatively, the seat bottom pans 14 and the seat backs 16 may be provided as a single integral structure, much like a bucket seat.

Referring now to FIG. 1, a rear surface 20 of the seat backs 16 features one or more connecting features 22 to secure the seat backs 16 together. It is important to note that the one or more connecting features 22 are specifically provided along the rear surface 20 and not along the surface or area 32 below the seat bottom pans 14. This is because one aspect of crashworthiness requires the bench 10 to be able to absorb vertical loads by stroking in a downward direction, as shown by the downward arrow on FIG. 1, upon a crash condition. Without this ability, the bench 10 would not be able to absorb the required forces. Accordingly, the typical method of providing a lower beam for connecting the seats to one another, such as in a traditional bench seating arrangement, would be unacceptable for the current crashworthy bench 10.

In FIG. 1, the connecting features 22 are provided by spreader elements 24 and beams 26. A spreader element 24 is positioned alongside each seat back 16 and has a receiving portion 28. A first beam 26 extends through each receiving portion 28 in order to secure the seat backs 16 to one another. In the particular embodiment shown, each spreader element 24 also has two additional lower receiving portions 28′ that receive a second beam 30. The first and second beams 26, 30 are generally parallel to one another. Beams 26, 30 run alongside the rear surface 20 of the seat backs 16; they do not extend to the area 32 below the seat pan, leaving the area 32 below the seat pan clear.

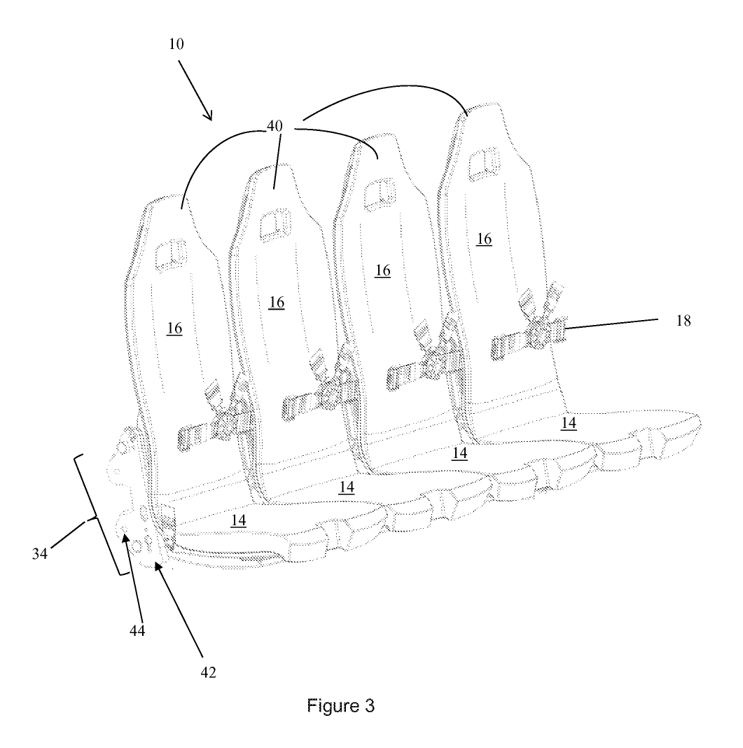

FIGS. 2 and 3 show a bench securing structure 34 for the bench 10. In FIG. 2, the bench securing structure 34 is provided as two side legs 36, one alongside each side of the bench 10. The legs 36 may either cooperate with a side spreader element 24 or they may be an integral extension of the side spreader element 24. In FIG. 2, the legs are integrally formed as extensions of the edge side spreader element on each side of the bench 10. Each leg 36 has an attachment fitting 38 that cooperates with a seat track on the floor (or the attachment fitting may cooperate directly with the aircraft floor). As shown, the present design requires only two legs 36 in order to secure the four seats 40 shown. A leg 36 on either side of the bench 10 may be provided, resulting in the use of only two legs 36, as opposed to the use of eight legs for securing four traditional crashworthy seats. Depending on the rotorcraft floor structure admissible interface loads, additional legs 36 might be added.

In FIG. 3, the bench securing structure 34 includes two side bulkhead attachment elements 42. The attachment element 42 may either cooperate with a side spreader element 24 or it may be an integral extension of the side spreader element 24. In FIG. 3, the attachment element is integrally formed as part of the side spreader element that is positioned on each side of the bench 10. Each attachment element 42 has one or more bulkhead attachment structures 44 that cooperate with an attachment location on the bulkhead wall. As shown, this design requires only two attachment elements 42 in order to secure the four seats 40 shown. A bulkhead attachment element 42 on either side of the bench 10 may be provided, resulting in the use of only two elements 42, as opposed to the use of eight legs for securing four traditional crashworthy seats. Depending on the rotorcraft wall structure admissible interface loads, additional attachment elements 42 might be added.

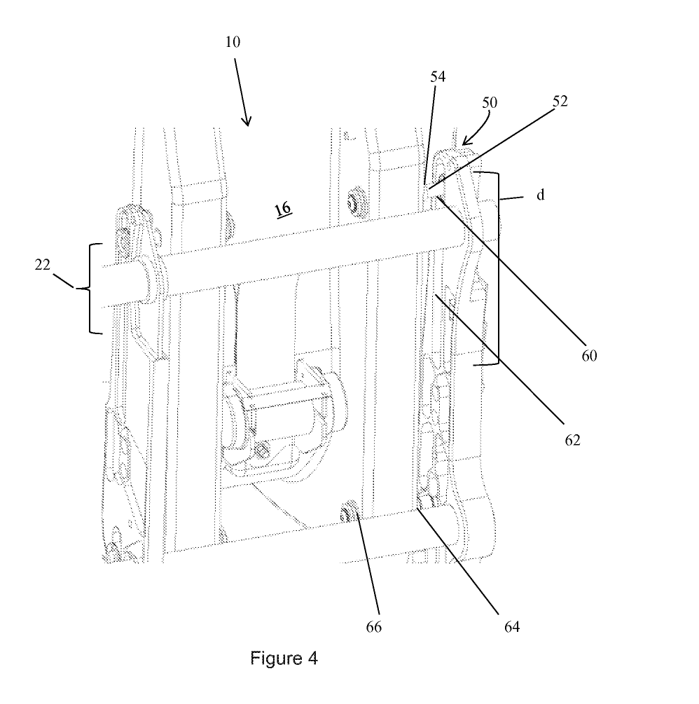

Referring back to FIG. 1, an energy absorption device 46 is also provided in the vicinity of the rear surface 20. The energy absorption device 46 will generally include an energy absorber 48 and a system 50 that allows vertical travel of the seat 40. There may be one energy absorber 48, or more than one energy absorber 48 may be provided. FIG. 1 shows a bench 10 with two energy absorbers 48 per seat. The energy absorber 48 may be any type of energy absorber, such as an FLEA, a VLEA, or any other energy absorber, many of which are known in the art and to which improvements continue to be developed. The system 50 for allowing vertical travel of the seat 40 is shown more clearly in FIG. 4, which shows the system with the energy absorber 48 removed.

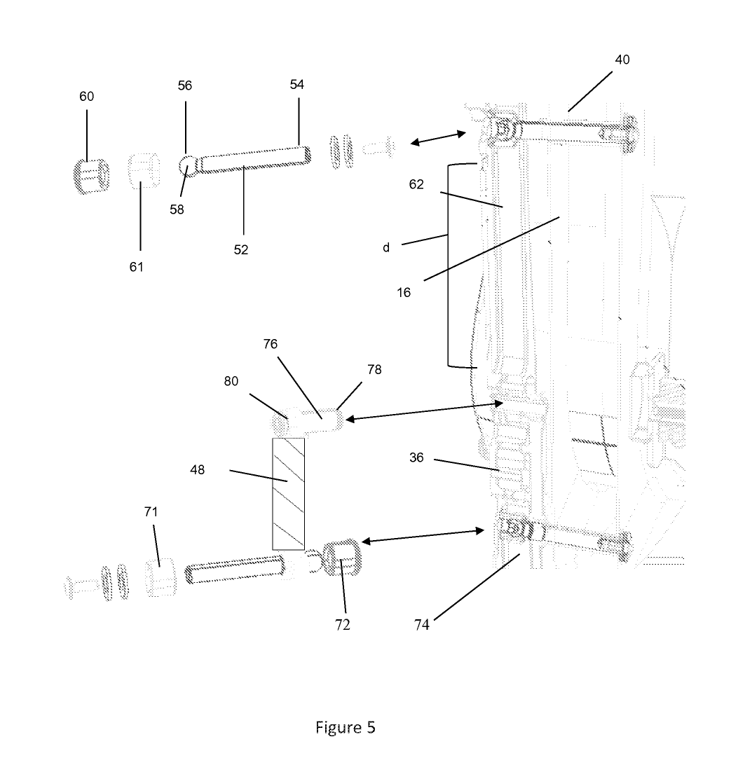

FIG. 5 shows an exploded view of selected portions of system 50. The system 50 may include a first shaft 52. A first end 54 of the first shaft 52 may be secured to the seat back 16. A second end 56 of the first shaft 52 may have a ball joint 58. The ball joint 58 may be inserted into a bearing 60 that can move freely in and interface with a groove 62 along an internal face of the spreader element 24. The groove 62 is generally vertical and extends a distance “d.” In one embodiment, the groove 62 provides a sliding surface for the bearing 60. It may extend from an upper portion of the spreader element 24 to a mid-portion of the spreader element 24. At a certain crash force, the bearing 60 will slide in the groove 62 in order to allow the bench 10 to stroke. An intermediate pad 61 may be provided to improve the sliding of the shaft 52.

Because the seat backs 16 of the seats 40 of the bench 10 are secured to one another via one or more connecting features 22, they all stroke together. Because there is not a beam or other connection or support structure provided beneath the seat bottom pans 14 of the seats 40 in order to secure them to one another, the floor, seat track, or bulkhead, the downward stroke movement is not limited.

A second shaft 64 is provided at a lower portion of the seat back 16. The second shaft has one end 66 that is secured to the seat back 16, and a second end 68 that provides a link to the EA 48. Second shaft 64 also has a ball joint 70 that cooperates with a second bearing 72. Second bearing 72 cooperates with a lower groove 74. An intermediate pad 71 may be provided to improve the sliding of the shaft 64.

FIG. 5 also shows a stationary shaft 76. This stationary shaft 76 may be secured to the leg 36. Stationary shaft 76 may have a first end 78 that is secured to the seat back 16 and a second end 80 that provides a link to the EA 48.

In use, a crash force may cause deformation of traditional shafts that are used to secure a seat back to a traditional leg. However, by providing a ball joint 58 on the end of the first shaft 52 that cooperates with a bearing 60 in the groove 62 and a ball joint 70 on the end of the second shaft 64 that cooperates with a bearing 72 in the groove 74, deformation upon impact can be limited or reduced. It may also lower the impact of any deformation that may occur. Limiting or lowering the deformation of the shafts 52, 64 allows them to more effectively cooperate with the system 50 for allowing vertical travel of the seat 40. The ball joint 58 inserted into the bearing 60 moves freely in an almost vertically oriented groove 62. Similarly, the ball joint 70 inserted into the bearing 72 moves freely in an almost vertically oriented lower groove 74. These cooperations can increase the efficiency of the EA 48.

Changes and modifications, additions and deletions may be made to the structures and methods recited above and shown in the drawings without departing from the scope or spirit of the invention and the following claims.

1. A crashworthy bench for an aircraft, comprising:
(a) an upper seat structure, comprising two or more seat bottom pans and two or more seat backs;
(b) one or more connecting features securing the two or more seat backs together, the one or more connecting features provided along a back surface of the seat backs or seat bottom pans or both, leaving an area below the seat bottom pans clear;
(c) an energy absorption device; and
(d) a bench securing structure positioned alongside first and second sides of the bench, each securing structure configured for securement of the bench to the aircraft.

2. The bench of claim 1, wherein the bench securing structure secures the bench to an aircraft floor, seat track, or bulkhead.

3. The bench of claim 1, wherein the one or more connecting features comprise one or more spreaders joined by a beam.

4. The bench of claim 3, wherein at least one of the one or more spreaders comprises an integral leg forming a portion of the bench securing structure.

5. The bench of claim 3, wherein at least one of the spreaders comprises a groove for receiving a ball joint of a shaft that secures the seat back to the spreader.

6. The bench of claim 1, wherein the bench securing structure comprises two legs.

7. The bench of claim 1, wherein the bench securing structure comprises two bulkhead attachment points.

8. The bench of claim 1, wherein the energy absorption device comprises more than one energy absorber.

9. A crashworthy bench for an aircraft, comprising:
(a) an upper seat structure, comprising two or more seat bottom pans and two or more seat backs;
(b) a bench securing structure positioned alongside first and second sides of the bench, each bench securing structure having (i) a base configured for securement of the bench to an aircraft structure and (ii) one or more grooves along an internal face;
(c) a first side of the bench having a first seat back comprising a system that allows vertical travel of the upper seat structure, the system comprising (i) a first shaft having a first end secured to seat back and a second end comprising a ball joint, the ball joint cooperating with a bearing received by the one or more grooves of the bench securing structure and (ii) a second shaft having a first end secured to the first seat back and a second end linked to an energy absorption device; and
(d) a second side of the bench having a second seat back comprising a second system that allows vertical travel of the upper seat structure.

10. The bench of claim 9, further comprising one or more connecting features for securing the two or more seat backs to one another.

11. The bench of claim 10, wherein the one or more connecting features comprise one or more spreaders joined by a beam.
